(19) United States
(12) Patent Application Publication
(10) Pub. No.: US 2012/0305431 A1
(43) Pub. Date: Dec. 6, 2012

(54) Easy-Open Envelope

(76) Inventors: Andrew William Floyd, Mesa, AZ (US); Gerald Jay Pirouznia, Gilbert, AZ (US)

(21) Appl. No.: 13/486,921

(22) Filed: Jun. 1, 2012

Related U.S. Application Data
(60) Provisional application No. 61/492,551, filed on Jun. 2, 2011.

(51) Int. Cl. B65D 27/38; B65D 27/34; B31B 1/90; B65D 27/14

(52) U.S. Cl. 206/459.5; 229/79; 229/313; 229/311; 493/212

(57) ABSTRACT

Disclosed is an easy-open envelope comprising a pocket for receiving and storing objects. The pocket further comprises a flap configured to be positioned in an open and closed position. The flap is further configured such that when positioned in a closed position, contents may not be added to or removed from the pocket. At least one of the flap interior or pocket exterior comprises an adhesive configured such that when the adhesive has been activated and the flap closed, the flap is secured to the pocket, and contents of the envelope pocket may not be accessed without destructively tearing some portion of the envelope. The easy-open envelope further comprises an embedded access device. The embedded access device is configured to permit easy access to the content of the easy-open envelope if the envelope has been sealed. A method for making the easy-open envelope is also provided.

### CROSS REFERENCE TO RELATED APPLICATION

This application claims priority to U.S. Provisional patent application to Andrew Floyd and Gerald Jay Pirouznia entitled “EASY OPEN ENVELOPE”, Ser. No. 61/492,551, filed Jun. 2, 2011, the disclosure of which is hereby incorporated entirely herein by reference.

### BACKGROUND OF THE INVENTION

1. Technical Field

The present application relates generally to easy-open packages used for storing, transporting, securing sending and receiving physical objects. More particularly, the present application relates to an easy-open envelope for securely containing and sending and/or receiving letters or other correspondence, and a method for making the same.

2. State of the Art

For many years, people have corresponded and/or communicated with each other using written messages presented on paper or other similar media. For various reasons, including the need to protect the messages from damage, the need to protect messages from prying eyes, and the need to include with the messages information calculated to make sure that the message arrives at a certain destination and is delivered to certain people and/or persons, messages have frequently been sent, stored, or transported contained in storage devices such as envelopes.

In order to insure that the contents of the message have been safely secured within the envelope, and to instill confidence that the contents of the message have not been accessed by anyone other than the addressee, envelopes have been typically sealed. This sealing has taken many forms, including but not limited to the use of heated wax positioned across the flap portion of the envelope designed to provide access to the envelope contents. More recently, the sealing has taken the form of a glue present on the envelope flap that can be moistened with the tongue such that when the moistened flap is folded across the opening, the envelope is sealed. Even more recently, the sealing has taken the form of an adhesive covered with a backing. When the backing is removed, the sticky adhesive portion is revealed, such that when the flap is folded across the envelope, the sticky adhesive portion adheres to the envelope in such a way as to seal the envelope.

Initially, devices for containing messages, including envelopes, were made by hand. With the arrival of the industrial age in the 1800s, envelopes began being mass produced by machines. In 1845 Edwin Hill and Warren de la Rue obtained a patent for a machine that automated the manufacturing of what we have come to know as the modern day envelope. Their machine enabled the mass manufacture of envelopes which were machine cut and folded. Since the patent of this machine, some changes have occurred in the manufacturing of envelope, such as, for example, changes in the method by which adhesive material is applied during the manufacturing of the envelope.

However, while much time and effort has been expended in the development of machinery to mass produce envelopes, little effort has been expended developing ways in which users of the envelope can more easily open the envelopes to access the messages or other content contained therein. More specifically, developments in envelopes permitting easy access to the content while still providing security for the contents until the envelope arrives to its intended recipient have been limited.

At present, methods available for accessing the contents of typical envelopes include using letter opener tools (which might be inconveniently located if available at all), attempting to force a finger into a small gap at the top of the envelope so that the envelope can be torn open along an edge by this repeated action along an edge of the envelope (risking tearing or harming the contents of the envelope and possible finger cuts as well), tapping the envelope on an object to attempt to force the contents to one end of an envelope, followed by a tearing off of the opposite end of the envelope (and hoping the contents haven't been destroyed or damaged in the process), followed by blowing into the end of the envelope so that the envelope “expands”, permitting one to access and remove the contents. In addition to posing the above-noted risks of damaging the envelope contents and possibly injuring fingers and/or nails, these methods also are disadvantageous in that they take more time than should be reasonably required to open the envelope and access the contents thereof. This is especially disadvantageous when the considerable volume of mail received by individuals and businesses on any given day is considered. Although in some cases envelopes have included perforations cut into an edge of the envelope in order to make opening the envelopes easier, these perforated envelopes do not overcome the shortcomings noted above. Finally, current envelopes opened as discussed above result in an open envelope having ragged, irregular edges. In addition to being aesthetically displeasing, these envelopes having ragged edges are more difficult to store and organize in an orderly fashion.

Accordingly, there is a need for an easy-open envelope that allows users to access the content of envelopes without risking injury to fingers and/or fingernails, without the need for external contraptions such as letter openers, and without wasting unnecessary time and energy. Furthermore, there is a need for a method for making such an envelope.

### SUMMARY OF THE INVENTION

In view of the foregoing disadvantages inherent in the prior art, the general purpose of the present invention is to provide an easy-open envelope and method for making the same that overcomes the drawbacks inherent in prior art envelopes by eliminating the difficulty, wasted time, inconvenience, need for special tools, and risk of injury associated with prior art envelopes and opening the same.

The easy-open envelope of the present invention comprises a pocket or pouch for receiving and storing objects. The pocket further comprises a flap configured to be positioned in an open and closed position. The flap is configured such that when positioned in an open position, contents may be readily added to or removed from the pocket. The flap is further configured such that when positioned in a closed position, contents may not be added to or removed from the pocket. At least one of the flap interior or pocket exterior comprises an adhesive configured such that when the adhesive has been activated and the flap closed (also referred to as sealing the envelope), the contents of the envelope pocket may not be accessed without tearing some portion of the envelope. The easy-open envelope further comprises an embedded access device. The embedded access device is configured to permit easy access to the content of the easy-open envelope if the envelope has been sealed. A method for making the easy-open envelope is also provided. When opened using the embedded access device, the easy-open envelope of the present invention has a “clean” opening (typically without ragged, irregular edges), making it easier to store and organize the easy-open envelopes once they have been opened.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 generally illustrates the easy-open envelope of the present invention in an open, unsealed state, according to an embodiment of the present invention;

FIG. 2 generally illustrates the easy-open envelope of the present invention in a closed, sealed state, according to an embodiment of the present invention;

FIG. 3 generally illustrates the easy-open envelope of the present invention having its embedded access device partially deployed, according to an embodiment of the present invention;

FIG. 4 generally illustrates the easy-open envelope of the present invention having its embedded access device fully deployed, according to an embodiment of the present invention;

FIG. 5 generally illustrates a method for making the easy-open envelope of the present invention, according to an embodiment of the present invention;

FIG. 6 generally illustrates an easy-open envelope of the present invention in a closed, sealed state, according to an alternate embodiment of the present invention; and,

FIG. 7 generally illustrates an easy-open envelope of the present invention in a closed, sealed state, according to an alternate embodiment of the present invention.

### DETAILED DESCRIPTION OF EMBODIMENTS OF THE INVENTION

As discussed above, embodiments of the present invention relate to an easy-open envelope and method for making and using the same.

Referring to the drawings and, more particularly to FIG. 1, the easy-open envelope 100 of the present invention comprises pocket 110 for receiving and storing objects. In the present embodiment, the size and configuration of pocket 110 are such that pocket 110 may receive and store multiple sheets of folded paper, such as, for example, typical paper of the size 8½ by 11 inches. In alternative embodiments, pocket 110 may have other sizes and configurations such that pocket 110 may receive, store and/or contain paper or other objects larger or smaller than 8½ by 11 inches.

The pocket 110 further comprises a flap 130 configured to be positioned in an open and closed position. In FIG. 1, flap 130 is generally illustrated in an open position. Flap 130 is configured such that when positioned in an open position, as shown in FIG. 1, contents may be readily added to or removed from the pocket 110. FIG. 1 generally illustrates the flap 130 as having a somewhat rectangular shape. In alternative embodiments, the flap 130 may have other shapes, such as, for example, a triangular shape.

The flap 130 is further generally illustrated in FIG. 1 having an adhesive 136 deposited on the interior surface 132 of the flap 130. In the present embodiment, the adhesive 136 is an adhesive that does not exhibit significant adhesive properties without having first been activated. Once activated, adhesive 136 is configured to adhere to the pocket exterior 120 of easy-open envelope 100 when the flap 130 is positioned in a closed position, maintaining the flap 130 in a closed position (also referred to as sealing the envelope). When the adhesive 136 has been activated and the flap 130 closed, the contents of the envelope pocket 110 may not be accessed without destructively tearing some portion of the envelope.

In the present embodiment, adhesive 136 is a glue that is activated by the application of moisture to the adhesive 136 by licking or applying moisture with a sponge device or other applicator. In an alternate embodiment, adhesive 136 may be an adhesive that is active when deposited on the easy-open envelope 100 during manufacture of the envelope, but that is covered with a removable covering until such time as the user wishes to expose the adhesive 136 to secure the flap 130 to the pocket exterior 120. In yet another alternative embodiment, rather than being deposited on the interior surface 132 of the flap 130, adhesive 136 is deposited on the pocket exterior 120 of easy-open envelope 100. In this alternative embodiment, adhesive 136 is deposited located on the pocket exterior 120 such that once it has been activated and the flap 130 has been placed in a closed position, the adhesive 136 will come into contact with the flap interior 132 of flap 130 such that flap 130 is secured to the pocket exterior 120 in a closed position by the adhesive 136.

FIG. 1 also generally illustrates easy-open envelope 100 having a fold 135. Fold 135 may also be referred to as a crease. Fold 135 is the location on envelope 100 along which the flap 130 folds when it is being moved from the open position to the closed position. FIG. 1 further generally illustrates an embedded access device 140. In the present embodiment, embedded access device 140 is positioned along the fold 135. In alternate embodiments, embedded access device 140 may be positioned in other locations on easy-open envelope 100, such as, for example, along other edges of easy-open envelope 100. In the present embodiment, embedded access device 140 is positioned along the fold 135 such that when the flap 130 is positioned in the closed position, a substantial portion of the embedded access device 140 will be inside the portion of the envelope pocket that results from the flap 130 being placed in the closed position.

Referring to FIG. 1, embedded access device 140 is further shown having exposed end 142 that would remain located outside the pocket 110 of the easy-open envelope 100 after the flap 130 has been placed in the closed position. In the present embodiment, exposed end 142 is simply a remaining exposed end of embedded access device 140. In an alternative embodiment, exposed end 142 is configured as a tab located inconspicuously in the upper right corner of the easy-open envelope 100 near where a postage stamp would be placed such that exposed end 142 can be grasped by fingers. In yet another alternate embodiment, exposed end 142 is attached to the outside surface of easy-open envelope 100 by means of removable gum paper such that it may be easily accessed by users but not accidentally pulled off.

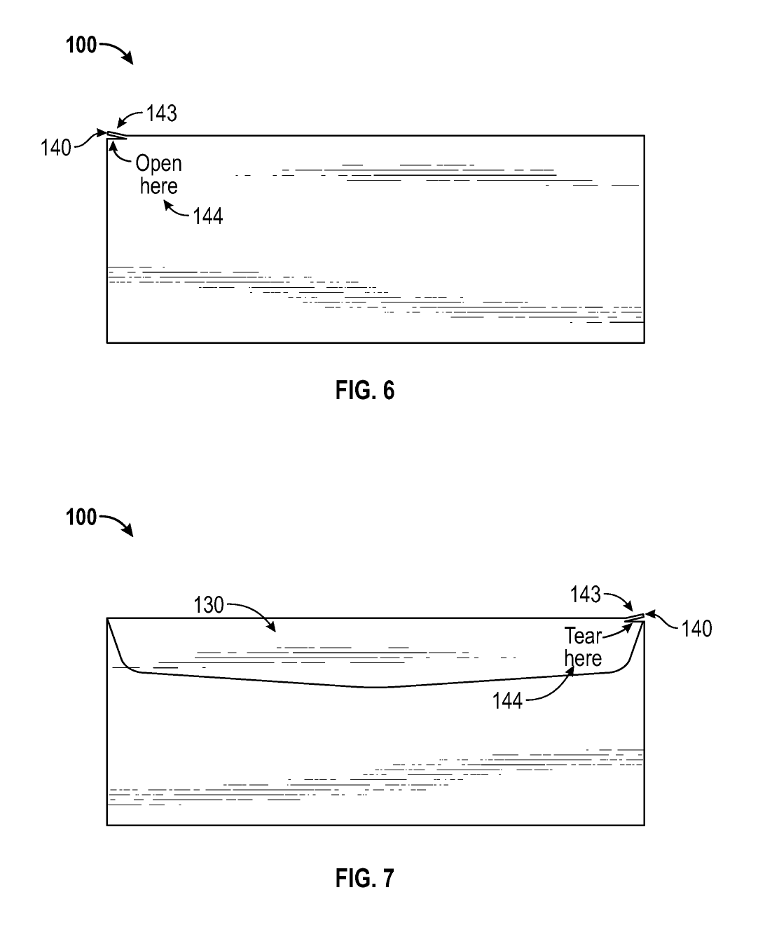

In still another alternate embodiment, generally illustrated in FIGS. 6 and 7, one end of embedded access device 140 is positioned in the upper left corner of the easy-open envelope 100 near where a return address would normally be located. In this embodiment, the one end of embedded access device 140 is positioned such what when the flap 130 of the easy-open envelope 100 has been placed in a closed position, the end itself is not readily visible or accessible external to the easy-open envelope 100. Rather, the end of embedded access device 140 is positioned near a small perforated area 143 located in the upper left corner, such that when the envelope corner near the small perforated area 143 is grasped and pulled, the end is pulled along with the envelope corner. In this alternate embodiment, the easy-access envelope 100 further includes a message 144 (such as, for example, “tear here” or “open here”) printed on at least one side of the easy-open envelope 100 in the vicinity of the perforated corner 143 of the easy-open envelope 100 indicating to the envelope user the location at which to grasp and pull the envelope corner in order to access and activate the embedded access device 140. It should be appreciated that in still other variations of this embodiment, the perforated corner of the envelope and corresponding end of embedded access device 140 may be located at other corners of the easy-access envelope 100.

In alternative embodiments where embedded access device 140 has been placed in a location other than along a fold 135 of easy-open envelope 100, embedded access device 140 includes at least one exposed end 142 remaining located outside the pocket 110 of the easy-open envelope 100 after the flap 130 has been placed in the closed position. The embedded access device 140 is configured to permit easy access to the content of the easy-open envelope 110 after the easy-open envelope 110 has been sealed.

In the present embodiment, embedded access device 140 is #30 waxed silk thread that has been inlayed and secured along fold 135 by gluing it directly along the fold using a thin layer of glue, such as, for example, mxbon 407 cyanocrylate adhesive. In alternate embodiments, embedded access device 140 is secured along fold 135 by applying a thin layer of a different adhesive or glue. In the present embodiment, embedded access device 140 is inlayed and secured along fold 135 such that it is concealed from view except for a small portion of exposed end 142. In alternate embodiments, embedded access device 140 is tussah silk thread, organic thread, biodegradable thread, or other thread or string. In still other alternate embodiments, embedded access device 140 is woven through gummed paper, and is secured to easy-open envelope 100 by pressing or rolling the gummed paper along the fold of easy-open envelope 100.

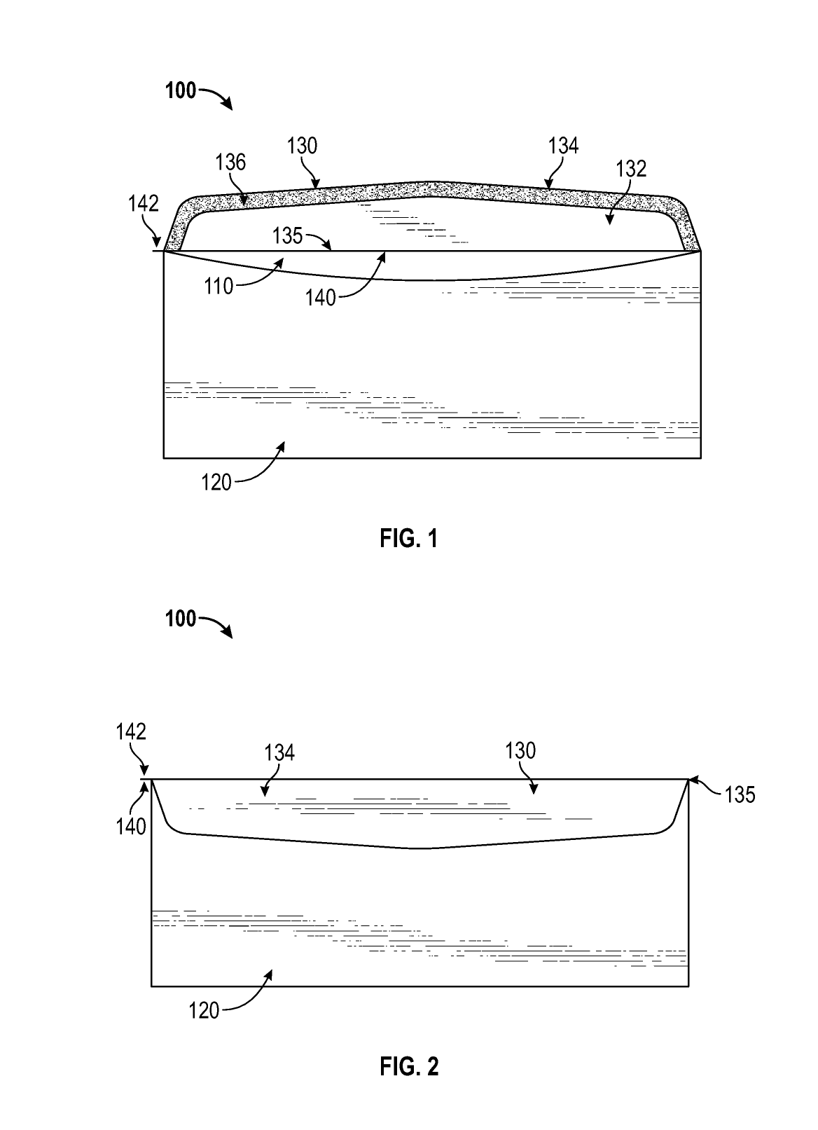

Referring to FIG. 2, in addition to being configured to be positioned in an open position as shown in FIG. 1 and discussed above, the flap 130 is also configured to be position in a closed position. FIG. 2 generally illustrates easy-open envelope 100, and a portion of flap exterior 134 of the closed flap 130 which has been sealed closed by securing the flap 130 to pocket exterior 120 by means of an adhesive 136. It will be appreciated that any content previously deposited in pocket 110 prior to sealing the easy-open envelope 100 can no longer be accessed unless easy-open envelope 110 is somehow destructively torn. FIG. 2 further generally illustrates exposed end 142 of embedded access device 140, which will permit, as will be discussed below, easy-open envelope 100 to be easily opened, allowing access to the contents of pocket 110.

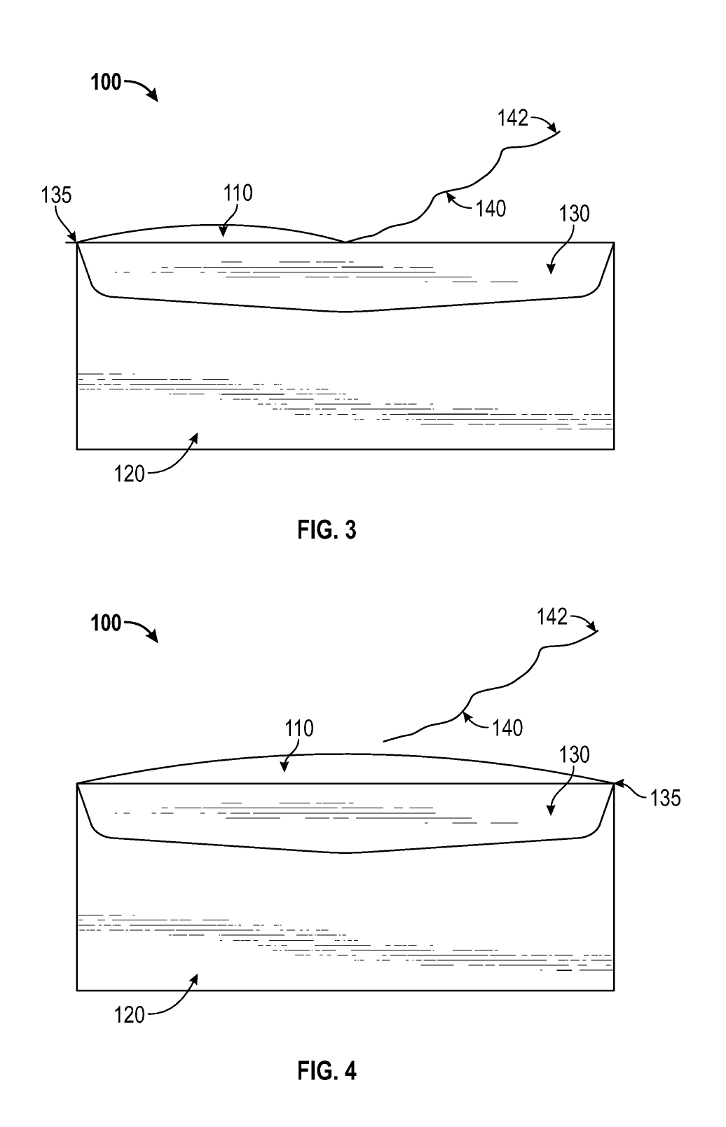

Referring to FIG. 3, the easy-open envelope 100 of FIG. 2 is generally illustrated having embedded access device 140 partially pulled by means of gripping exposed end 142 and pulling exposed end 142 while the remaining portion of easy-open envelope 100 is held securely. As can be seen in FIG. 3, the pulling of exposed end 142 of embedded access device 140 results in the tearing open of easy-open envelope 100 along the fold 135. The resulting tear has exposed a portion of pocket 110 of easy-open envelope 100 and the contents therein, and previously hidden portions of embedded access device 140.

Referring to FIG. 4, the easy-open envelope 100 of FIG. 3 is generally illustrated having embedded access device 140 fully removed from easy-open envelope 100. This has been accomplished by continuing to pull the exposed end 142 of embedded access device 140 until embedded access device 140 completely separates from the easy-open envelope 100. As can be seen in FIG. 4, the resulting tearing of easy-open envelope 100 has completely exposed the interior pocket 110 of easy-open envelope 100 such that the contents of interior pocket 110 may be easily accessed. Furthermore, the removal of embedded access device 140 has exposed the previously hidden portions of embedded access device 140.

It should be appreciated that in contrast to prior-art envelopes, the easy-open envelope 100 of the present invention permits easy, efficient access to the contents of the pocket 110 of the envelope by simply pulling on the embedded access device 140, rather than by using external tools, or other less efficient means that also risk injury to fingers and destruction of the contents of the pocket. Furthermore, the easy-open envelope 100, once opened using the embedded access device 140, has a clean opening, rather than an opening having ragged, irregular tears along the edges of the envelope opening, making the easy-open envelope 100 easier to store and organize than prior art envelopes.

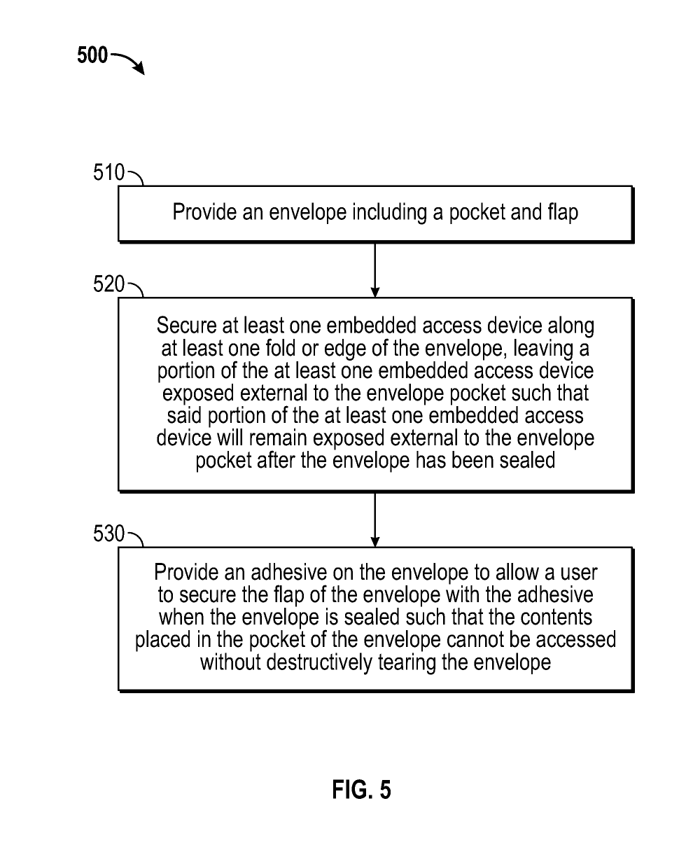

Referring to FIG. 5, a method 500 for making an easy open envelope 100 is provided. According to a first step 510, an envelope including a pocket and flap is provided. In a second step 520, an embedded access device is secured along a fold or edge of the envelope, leaving a portion of at least one end of the embedded access device exposed external to the envelope pocket. In a third step 530, an adhesive is provided on the envelope to allow a user to secure the flap to the exterior of the envelope such that contents placed in the pocket of the envelope may not be accessed without destructively tearing the envelope.

In an alternate embodiment of the method, step 530 may precede step 520. In yet another alternate embodiment, steps 530 and 520 may occur simultaneously during the manufacture of the easy-open envelope. In still another alternate embodiment, an embedded access device may be secured to the easy-open envelope prior or simultaneously to the forming of the various portions of the envelope (such as the pocket and flap) and prior or simultaneously to the application of adhesive used for securing the flap of the easy-open envelope to the exterior of the easy-open envelope.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

What is claimed is:

1. An envelop comprising a pocket having an interior and exterior, wherein said pocket is configured for receiving and storing objects; a flap configured to be positioned in each of an open and closed position, wherein said flap inhibits access to objects located within the interior of said pocket when said flap is in a closed position; an adhesive located on at least one of a surface of said pocket or said flap, wherein said adhesive is configured to secure said flap in a closed position when said flap is closed; and an embedded access device attached to said envelope and configured to provide access to the interior of said pocket when pulled.

2. The envelope of claim 1, further comprising a fold along which said flap folds when being positioned in a closed position.

3. The envelope of claim 2, wherein said embedded access device is positioned along said fold.

4. The envelope of claim 1, wherein said embedded access device includes a portion that remains exposed outside the envelope pocket when said flap is placed in a closed position.

5. The envelope of claim 4, wherein the exposed portion of said embedded access device is secured to an external surface of said envelope.

6. The envelope of claim 1, wherein said envelope further comprises a perforated corner configured to be removable from said envelop by pulling.

7. The envelope of claim 6, wherein a portion of said embedded access device is attached to said perforated corner.

8. The envelope of claim 7, wherein said embedded access device is not visible external to said envelope when said pocket is closed.

9. The envelope of claim 7 further comprising a message printed on the exterior of said envelope near said perforated corner instructing users of said envelope to utilize said perforated corner.

10. The envelope of claim 1, wherein said embedded access device is positioned along at least one edge of said envelope.

11. The envelope of claim 1, wherein said embedded access device is positioned internal to said envelope when said flap is in a closed position.

12. The envelope of claim 1, wherein said embedded access device is a thread.

13. The envelope of claim 12 wherein said thread is at least one of tussah, organic and biodegradable.

14. The envelope of claim 1, wherein said embedded access device is secured to said envelope by an adhesive material.

15. The envelope of claim 1, wherein said embedded access device is woven through gummed paper, and wherein said gummed paper is secured to said envelope.

16. An envelope comprising: a pocket having an interior and an exterior, said pocket configured to receive and store paper in the interior of said pocket; a flap configured to be positioned in each of an open and closed position, wherein said flap inhibits access to objects positioned within the interior of said pocket when said flap is in a closed position; a fold along which said flap closes when positioned in a closed position; an adhesive located on at least one of a surface of said envelope or said flap, wherein said adhesive is configured to secure said flap in a closed position when said flap is closed; an embedded access device comprising a thread secured along an entire length of said fold by an adhesive material; and a perforated tab formed in at least one corner of said envelope and secured to said embedded access device.

17. A method for making an easy-open envelope comprising the steps of: providing an envelope having a pocket for storing objects and a flap capable of being positioned to inhibit access to said pocket; depositing an adhesive on at least one of an exterior surface of said envelope and said flap; securing an embedded access device along at least one edge of said pocket; forming a perforated tab into at least one corner of said envelope; and securing a portion of said embedded access device to said perforated tab.
